(19) United States
(12) Patent Application Publication
(10) Pub. No.: US 2007/0237870 A1
(43) Pub. Date: Oct. 11, 2007

(54) Freeze dried grape powder

(75) Inventors: Courtney Romano, Kirkland, WA (US); Kathleen Nave, Fresno, CA (US); Jim Howard, Fresno, CA (US)

Correspondence Address: MORRISON & FOERSTER LLP, 425 MARKET STREET, SAN FRANCISCO, CA, 94105-2482, US

(73) Assignee: CALIFORNIA TABLE GRAPE COMMISSION, Fresno, CA (US)

(21) Appl. No.: 11/400,450

(22) Filed: Apr. 6, 2006

(51) Int. Cl. A23C 1/06

(52) U.S. Cl. 426/384; 426/385

(57) ABSTRACT

This invention provides a grape powder in the form of a freeze-dried powder that is representative of different grape varieties that are widely consumed. The grape varieties that can be used in the practice of this invention include table grapes, juice grapes, wine grapes, or combinations of these types of grapes. The inventors have also provided a method of producing a grape powder in the form of a freeze-dried powder that is representative of the different grape varieties that are consumed.

### BACKGROUND OF THE INVENTION

Grapes are among the most popular fruits consumed in the United States and worldwide. Taste and convenience are among the top reasons for the popularity of grapes, but grapes also have high nutritional and disease prevention value as well. Grapes are high in vitamin C and contain a variety of phytonutrients. Phytonutrients are substances found in plant foods that are involved in disease prevention. Some phytonutrients are antioxidants that help prevent cell damage that can lead to disease. For example, some of the phytonutrients in grapes may help prevent heart disease by inhibiting the build up of plaque in coronary arteries. As another example, grapes are one of the few foods that contain resveratrol, a phytonutrient that has been shown to slow down tumor growth in animals.

Fresh grapes contain about 82% water, 12-18% sugar, and 0.2-0.8% acid, mainly tartaric and malic acid. Grapes also contain numerous phenolic compounds, including simple phenols, simple phenolic acids, cinnamic acids, stilbenes, flavonoids, flavans, flavonols, and anthocyanins. Grapes are high in flavonoids and are particularly good sources of flavans. The major phenolic compound in grapes is catechin, and grapes also contain epicatechin, gallocatechin, and epigallocatechin. Furthermore, grapes also contain high concentrations of leucoanthocyanidin flavans of varied structure. Grapes are good sources of flavonols, primarily quercetin.

Given the high nutritive value of grapes and the wide variety of grapes that are consumed at different times of the year due to differences in growth seasons, it would be advantageous to have a preparation of grapes that is representative of commonly consumed grapes that may be used as a nutritional supplement, as a medicine to treat disease or slow aging, or as a starting material for further scientific investigation into the health benefits of grape consumption.

### BRIEF SUMMARY OF THE INVENTION

A freeze-dried powder that is representative of different grape varieties that are consumed is provided herein. The grape varieties that can be used include table grapes, juice grapes, wine grapes, or combinations of these types of grapes. The grapes may be seedless or contain seeds. A method of producing a freeze-dried grape powder that is representative of the different grape varieties that are consumed is also described.

In one embodiment, a freeze-dried grape powder which is derived from the freeze drying of one or more whole table grape varieties is provided. Among the table grapes that can used in the practice of this invention include but are not limited to Flame Seedless, Tokay, Black Beauty, Superior, Emperor, Calmeria, Exotic, Italia, Malaga, Cardinal, Peerlette, Barlinka, Blackrose, Queen, Seedless, Thompson Seedless, Red Globe, Ruby Seedless, Crimson Seedless, Ribier, Sugraone, Christmas Rose, and Fantasy Seedless.

In another embodiment, the invention provides a freeze dried grape powder which is derived from the freeze drying of the whole grapes of one or more juice grape varieties. Among the juice grapes that can used are Concord and other juice grapes.

In yet another embodiment, a freeze dried grape powder which is derived from the freeze drying of the whole grapes of one or more wine grape varieties is provided. In certain embodiments, two or more wine grape varieties, three or more wine grape varieties, four or more wine grape varieties, five or more wine grape varieties, six or more wine grape varieties, seven or more wine grape varieties, eight or more wine grape varieties, nine or more grape varieties, ten or more grape varieties or more than ten wine grape varieties are utilized in the formation of the freeze dried grape powder. Among the wine grapes that can be used include but are not limited to Burger, Chardonnay, Chenin Blanc, Emerald Riesling, French Colombard, Gewurztraminer, Gray Riesling, Malvasia Bianca, Marsanne, Muscat Blanc, Muscat of Alexandria, Muscat, Cabernet, Merlot, Palomino, Pinot Blanc, Pinot Gris, Roussanne, Sauvignon Blanc, Sauvignon Musque, Semillon, St Emilion, Symphony, Tocai Friulano, Viognier and White Riesling.

In further embodiments, a freeze dried grape powder which is derived from the freeze drying of whole grapes of one or more table grape varieties that are grown in Coachella Valley, California is provided. Examples of such grape varieties include but are not limited to, Flame Seedless, Perlette Seedless, and Thompson Seedless.

In further embodiments, freeze dried grape powder which is derived from the freeze drying of one or more grape varieties that are grown in San Joaquin Valley, California is provided. Examples of such grape varieties include Thompson Seedless, Flame Seedless, Red Globe, Ruby Seedless, Crimson Seedless, Ribier, Sugraone, Christmas Rose, and Fantasy Seedless.

In other embodiments, a method for producing a freeze-dried grape powder is provided. The method may include the steps of (a) selecting whole grapes wherein some of the whole grapes may include stems; (b) removing the stems from the whole grapes with stems to form a mixture of stemless grapes; (c) grinding the mixture of stemless grapes in a cooling agent to form a frozen ground grape mixture; (d) freeze-drying the frozen ground grape mixture to form a freeze-dried ground grape mixture, and (e) grinding the freeze-dried ground grape mixture to produce a freeze-dried grape powder. The freeze dried grape powder is composed of a mixture of one or more grape varieties. Where two or more grape varieties are utilized in the method, the mixture of two or more grape varieties can be formed at any step in the process so long as the final composition contains two or more grape varieties.

In certain embodiments, the freeze-dried grape powder may include two or more wine grape varieties, three or more wine grape varieties, four or more wine grape varieties, five or more wine grape varieties, six or more wine grape varieties, seven or more wine grape varieties, eight or more wine grape varieties, eight or more wine grape varieties, nine or more grape varieties, ten or more grape varieties or more than ten wine grape varieties.

The cooling agent may be liquid nitrogen or dry ice.

### DETAILED DESCRIPTION OF THE INVENTION

Given the high nutritive value of grapes and the wide variety of grapes that are consumed at different times of the year due to differences in growth seasons, it would be advantageous to have a preparation of grapes that is representative of commonly consumed grapes. A standardized grape preparation in the form of a freeze-dried grape powder that is representative of commonly consumed grapes is provided herein. In various embodiments, the powder is a representative sample of table, juice, or wine grapes collected and freeze-dried into an edible grape powder. Also provided are methods for making such a preparation. The freeze-dried grape powders described herein can be used for a variety of purposes. Such uses include use as a nutritional supplement or as a starting material for the further study of the beneficial effects of grape consumption, or as medicine to treat or prevent disease or slow aging. As an example, the grape powders described herein can be used as a starting material for the isolation of beneficial compounds such as phytonutrients including phenolic compounds and flavonoids, as examples. The grape powders contain high amounts of sugar that can be used as a substitute for sweeteners such as high fructose corn syrup.

The grapes described herein can be any grapes grown world wide. Grapes that find use include table grapes, juice grapes and wine grapes. The grapes may be seedless or contain seeds. The grapes used to make the freeze dried grape powder are whole grapes.

Table grapes are grapes intended for consumption while they are fresh and intact, as opposed to grapes grown for juice or wine production. Examples of table grapes include but are not limited to: Flame Seedless, Tokay, Black Beauty, Superior, Emperor, Calmeria, Exotic, Italia, Malaga, Cardinal, Peerlette, Barlinka, Blackrose, Queen, Seedless, Thompson Seedless, Red Globe, Ruby Seedless, Crimson Seedless, Ribier, Sugraone, Christmas Rose, and Fantasy Seedless. In contrast, juice grapes are grapes that are generally not eaten intact and fresh, but which rather, are generally crushed or pressed to make juice that is not fermented. Concord grapes are just one example of juice grapes. Wine grapes are grapes that are not generally eaten intact and fresh, but which are instead crushed or pressed to make juice which is then fermented to form an alcoholic beverage such as wine or champagne. Examples of wine grapes include, but are not limited to: Burger, Chardonnay, Chenin Blanc, Emerald Riesling, French Colombard, Gewurztraminer, Gray Riesling, Malvasia Bianca, Marsanne, Muscat Blanc, Muscat of Alexandria, Muscat, Cabernet, Merlot, Palomino, Pinot Blanc, Pinot Gris, Roussanne, Sauvignon Blanc, Sauvignon Musque, Semillon, St Emilion, Symphony, Tocai Friulano, Viognier, White Riesling. While the grapes listed have been broken down into categories based on primary usage, the skilled artisan will recognize that these classifications are not absolute and serve only as general guidelines. For example, a grape that is primarily a table grape might be used to make juice, or a juice grape might be used to make wine.

Among the grapes that find particular use are California table grapes. In some embodiments such grapes are ones grown in the Coachella Valley of California. Among the varieties of grapes that are grown in the Coachella Valley are Flame Seedless, Perlette Seedless, and Thompson Seedless. In other embodiments, the grapes can include grapes generally grown in the San Joaquin Valley of California. Grapes grown in the San Joaquin Valley include Thompson Seedless, Flame Seedless, Red Globe, Ruby Seedless, Crimson Seedless, Ribier, Sugraone, Christmas Rose and Fantasy Seedless.

Selection of Grape Varieties

A number of different methods may be used to select grape varieties and their percentages to be used in preparing freeze dried grape powder described herein. One formulation is made by including the most commonly consumed grapes in the United States in percent amounts that correlate with the market share of each grape variety. Such information on the amount of consumption of different grapes by variety can be obtained from a number of sources such as California Table Grape Commission. Such a grape powder is useful for purposes that require a sample that is reflective of overall grape consumption across all varieties commonly consumed.

In another embodiment, grape powder can also be made that are made from whole grapes from particular growing regions. In further embodiments, whole grapes are weighed out according to the ratios of grapes generally consumed by consumers prior to preparation of freeze dried grape powder. Grape powder can also be made from grapes of particular sugar content, phytonutrient concentrations, or other compounds or component of interest found in grapes. Through the selective manipulation of the type and amount of grape varieties that go into the formulation the grape powder, compositions may be obtained that are particularly high in nutritional value or which might serve as an enriched source of starting materials for research studies.

Preparation of Grape Powder

Fresh grapes are harvested and then delivered to a manufacturing facility where the grapes are first rinsed with cold water. Those grapes with stems are then de-stemmed to form a mixture of stemless grapes. The de-stemming process can be performed manually or mechanically. Examples of de-stemming methods that may be utilized include adaptation of methods and devices as disclosed in U.S. Pat. Nos. 4,152,977, 4,936,205, and 5,203,259 which are hereby incorporated by reference.

Following de-stemming, the mixture of stemless grapes is mixed with a cooling agent to form frozen, stemless grapes. The use of a cooling agent is important for keeping the preparation at very cold temperatures during the grinding and powdering process. In one format, dry ice is utilized. Alternatively, liquid nitrogen may be used. The advantages of using dry ice or liquid nitrogen as the cooling agent is that both these agents evaporate as gases upon warming and are readily available. Generally, dry ice is preferred.

Following or concurrently with the cooling step, the stemless grapes are ground to form a ground, frozen grape mixture. Many different grinding mechanisms will find use in the methods described herein. One particularly useful grinding mechanism is the use of a Rietz hammer mill. Other grinding mechanisms that may find use include those described in U.S. Pat. Nos. 4,418,500, 4,930,708, 5,509,610, and 5,733,173 which are hereby incorporated by reference. Regardless of the exact grinding method used, the grinding of the grapes should be performed at very cold temperatures, i.e., temperatures less than 35° F. In one format the grapes are ground in the presence of dry ice. In another format, they are ground in the presence of liquid nitrogen. In another format, the grapes are ground in a refrigerated room. In a preferred format, the grapes are frozen by grinding them in dry ice.

The ground, frozen grape mixture can be stored in moisture-proof-containers at or below 32° F. The moisture-proof containers can be vacuum packed. The ground, frozen grape mixture can then be transferred, e.g., transported via frozen truck to a freeze-drying facility where the ground, frozen grape mixture can be freeze-dried and then further ground into a grape powder of desired consistency. In one embodiment, the powder is ground to a coarse consistency comparable to sandbox sand. The resulting powder can be sieved prior to blending, pouching or packaging, using, for example, a sieving device to derive a powder of a desired particle size. In one format a 30 mesh screen is used for sieving. In another format, a 40 mesh screen is used for sieving. The freeze drying, grinding, blending, pouching and packaging is preferably done at or below 32° F.

In one embodiment, the resulting grape powder is comprised of two or more different varieties of grapes. It is understood that while the final product contains a combination of two or more varieties of grapes, the combining of different varieties can occur at any stage in the process of making the freeze dried grape powder. For example, the initially selected whole grapes can be a combination of two or more grape varieties. Alternatively, the grapes may be from a single variety or multiple varieties. The grapes may be seedless or contain seeds. The grapes may be table grapes, juice grapes or wine grapes. Alternatively, de-stemmed grapes of multiple varieties can be combined to form a mixture of stemless grapes containing two or more grape varieties. In another example, frozen stemless grapes of multiple varieties can be combined to form a mixture of frozen stemless grapes containing three or more grape varieties. In another example, the ground frozen grape mixture can be stored at or below 32° F. until mulitple varieties of grapes have been ground. Two or more varieties of grapes may be added to the grinding mixture to achieve the final desired composition. In another example, the freeze-dried ground grape powder of two or more different grape varieties can be combined. Once combined, the freeze-dried grape powder is best stored in a vacuum-packed container.

Uses

The grape powder described herein is suitable for consumption in a variety of formats. The grape powder can be suspended in water or another suitable beverage or liquid for consumption as a beverage. Alternatively, the grape powder can be used as an ingredient for cooking, such as in the preparation of baked goods. The grape powder may find use as a sugar substitute.

The grape powder described herein can also be used in scientific and medical investigations. For instance, the grape powder of the present invention can be used as a starting material for the isolation and testing of components from grapes that are beneficial to human and animal health. In addition, this grape powder can be used to simulate the grape components consumed on average by consumers during a certain time period.

The grape powder may be utilized directly, for example, like a “wheat-germ” extract or as a medicine for the treatment of disease or aging. They may also find use in cosmetics.

A nutrient analysis of a representative freeze-dried grape powder produced by the methods described herein is described in Table 1. Nutrients were analyzed by procedures well known in the art.

TABLE I

| Assay | per 100 g powder | Units |
|---|---|---|
| Calories | 375 | kcals |
| Total Fat, acid hydrolysis | 0.6 | g |
| Total Carbohydrate | 89.1 | g |
| Protein (N × 6.25) | 3.3 | g |
| Beta carotene | 0.14 | mg |
| Vitamin A from carotene | 230 | IU |
| Vitamin C | 2.3 | mg |
| Calcium | 45.0 | mg |
| Iron | 1.4 | mg |
| Sodium | 19.4 | mg |
| Potassium | 811 | mg |
| Thiamin HCl | 0.15 | mg |
| Folic Acid | 26 | μg |
| Phosphorus | 79 | mg |
| Magnesium | 23.7 | mg |
| Zinc | 0.24 | mg |
| Copper | 94 | μg |
| Manganese | 0.18 | mg |
| Moisture | 0.9 | g |
| Ash | 6.1 | g |

What is claimed as new and desired to be protected by Letters Patent of the United States is:

1. A method for producing a freeze-dried grape powder comprising:
(a) selecting whole grapes wherein said whole grapes comprise one or more grape varieties, wherein said whole grapes may contain stems;
(b) removing the stems from said whole grapes containing stems to provide a mixture of stemless grapes;
(c) grinding the mixture of stemless grapes in a cooling agent to form a frozen ground grape mixture;
(d) freeze-drying the frozen ground grape mixture to form a freeze-dried ground grape mixture; and
(e) grinding the freeze-dried ground grape mixture to produce a freeze-dried grape powder.

2. The method of claim 1 wherein said cooling agent is liquid nitrogen.

3. The method of claim 1 wherein said cooling agent is dry ice.

4. The method of claim 1 wherein the freeze-dried grape powder comprises two or more grape varieties.

5. The method of claim 1 wherein the freeze-dried grape powder comprises three or more grape varieties.

6. The method of claim 1 wherein the freeze-dried grape powder comprises four, five, six, seven, eight, nine or ten or more grape varieties.

7. The method of claim 1 wherein the one or more grape varieties are table grape varieties.

8. The method of claim 7, wherein the table grape varieties are selected from the group consisting of Flame Seedless, Tokay, Black Beauty, Superior, Emperor, Calmeria, Exotic, Italia, Malaga, Cardinal, Peerlette, Barlinka, Blackrose, Queen, Seedless, Thompson Seedless, Red Globe, Ruby Seedless, Crimson Seedless, Ribier, Sugraone, Christmas Rose, and Fantasy Seedless

9. The method of claim 1, wherein the one or more grape varieties are wine grape varieties.

10. The method of claim 9, wherein the wine grape varieties are selected from the group consisting of Burger, Chardonnay, Chenin Blanc, Emerald Riesling, French Colombard, Gewurztraminer, Gray Riesling, Malvasia Bianca, Marsanne, Muscat Blanc, Muscat of Alexandria, Muscat, Cabernet, Merlot, Palomino, Pinot Blanc, Pinot Gris, Roussanne, Sauvignon Blanc, Sauvignon Musque, Semillon, St Emilion, Symphony, Tocai Friulano, Viognier and White Riesling

11. The method of claim 1 wherein said one or more grape varieties are selected from the group consisting of Flame Seedless, Perlette Seedless and Thompson Seedless.

12. The method of claim 1 wherein said one or more grape varieties are selected from the group consisting of Thompson Seedless, Flame Seedless, Red Globe, Ruby Seedless, Crimson Seedless, Ribier, Sugraone, Christmas Rose and Fantasy Seedless.

13. A freeze-dried grape powder produced by the method of claim 1.

14. A method for producing a freeze dried grape powder comprising:
(a) selecting whole grapes wherein said whole grapes may contain stems;
(b) removing the stems from said whole grapes containing stems to provide a mixture of stemless grapes;
(c) grinding the stemless grapes in a cooling agent to form a ground frozen grape mixture;
(d) freeze-drying the ground frozen grape mixture to form a freeze-dried ground grape mixture; and
(e) grinding the freeze-dried ground grape mixture to produce a grape powder wherein said grape powder comprises one or more grape varieties.

15. The method of claim 14 wherein said grapes selected in step (a) comprise two or more grape varieties.

16. The method of claim 14 wherein the mixture of stemless grapes of step (b) comprises two or more grape varieties.

17. The method of claim 14 wherein the ground frozen grape mixture of step (c) comprises two or more grape varieties.

18. The method of claim 14 wherein the freeze-dried ground grape mixture of step (d) comprises two or more grape varieties.

19. The method of claim 14 wherein the freeze-dried grape powder comprises three, four, five, six, seven, eight, nine or ten or more grape varieties.
